(19) United States
(12) Patent Application Publication
(10) Pub. No.: US 2002/0124600 A1
(43) Pub. Date: Sep. 12, 2002

(54) Drawing method for optical fiber

(76) Inventors: Takahiro Hamada, Sakura-shi (JP); Munehisa Fujimaki, Sakura-shi (JP)

Correspondence Address: BELL, BOYD & LLOYD, LLC, PO BOX 1135, CHICAGO, IL, 60690-1135, US

(21) Appl. No.: 10/054,474

(22) Filed: Jan. 22, 2002

(30) Foreign Application Priority Data
Jan. 31, 2001 (JP) P2001-024921

(51) Int. Cl. C03B 37/07

(52) U.S. Cl. 65/384

(57) ABSTRACT

The present invention provides a drawing method for optical fiber, which is capable of reducing attenuation at 1.55 um due to Rayleigh scattering, even if the drawing speed is high. The reduction of the attenuation of the optical fiber 3 is realized by conducting a preliminary cooling in a first cooling zone 4, which has a low convection heat transfer coefficient, for reducing the temperature of the as-drawn optical fiber just before entering into a second cooling zone 5. The optical fiber is obtained after being cooled in the second cooling zone 5, which has a higher convection heat transfer coefficient.

### BACKGROUND OF THE INVENTION

1. Field of the Invention

The present invention relates to a drawing method for optical fiber, and in particular, relates to a drawing method for the optical fiber, capable of reducing an attenuation at around 1.55 μm.

2. Description of the Related Art

Conventional drawing methods for drawing optical fiber have been carried out by use of a drawing apparatus schematically shown in FIG. 4. The drawing apparatus comprises a drawing furnace 1 for melting and drawing a glass preform 2 and a cooling apparatus 7 for cooling optical fiber, which is maintained at a high temperature. In the drawing furnace, the glass preform 2 is melted at about 2,000° C. and is drawn into optical fiber 3, and optical fiber 3 is then rapidly cooled using a cooling apparatus such as a cooling cylinder. The optical fiber is wound on a drum after being coated with a coating resin.

However, when the optical fiber is formed by the above-described conventional drawing method, a problem arises in that the attenuation is caused at around 1.55 μm.

It is assumed that an increase of the attenuation at around 1.55 μm is caused due to Rayleigh scattering of the glass. Rayleigh scattering occurs due to density variations or concentration variations in glass, which is generated when it is cooled from a high temperature. The temperature, at which quenching of glass starts, generally determines the degree of density variation or the concentration variation. This temperature is often called the fictive temperature and is one of the indices indicating the glassy state. Therefore, the degree of Rayleigh scattering depends of the fictive temperature.

A technique pertaining to the cooling rate for an optical fiber for controlling Rayleigh scattering is disclosed in Japanese Patent Application, First Application No. Hei 10-218635.

### SUMMARY OF THE INVENTION

From the point of view of the relationship between the fictive temperature at which glass starts solidifying and Rayleigh scattering of glass, the present invention provides a drawing method for an optical fiber which is capable of reducing the Rayleigh scattering of glass and also reducing an attenuation at around 1.55 μm, even if the drawing speed is high.

According to the first aspect of the present invention, the present invention provides a drawing method for manufacturing optical fiber by cooling optical fiber drawn from the drawing furnace comprising: a first cooling step for cooling optical fiber to below 1100° C. in a first cooling zone in which convection heat transfer coefficient is set lower than 0.2 W·m⁻²·K⁻¹; and a second cooling step for cooling the optical fiber at the temperature below 1100° C. in a second cooling zone whose convection heat transfer coefficient is set higher than 0.3 W·m⁻²·K⁻¹.

According to the second aspect, in the above drawing method for manufacturing the optical fiber, in the first cooling zone filled with air, the optical fiber is naturally cooled for longer than 0.08 second after the temperature of the optical fiber reaches a temperature that is less than the softening temperature.

According to the third aspect, in the above drawing method for manufacturing optical fiber, the first cooling zone is a zone which is filled with a gas or a gas mixture, whose heat transfer coefficient is less than 0.05 W·m⁻¹·K⁻¹.

According to a fourth aspect, in the above drawing method for manufacturing optical fiber, said first cooling zone is provided with a protecting tube which is filled with a gas or a gas mixture, whose heat transfer coefficient is less than 0.05 W·m⁻¹·K⁻¹.

According to the fifth aspect, in the above drawing method for manufacturing optical fiber, the protecting tube has an inner diameter of greater than 10 mm and has a length sufficient for protecting the optical fiber while being cooled from a temperature above the transition temperature to a temperature below 1100° C.

### BRIEF DESCRIPTION OF THE DRAWINGS

FIG. 1 is a diagram showing a cooling apparatus employed for in drawing method for an optical fiber according to the first embodiment of the present invention.

FIG. 2 is a diagram showing a cooling apparatus employed in the drawing method for an optical fiber according to the second embodiment of the present invention.

FIG. 3 is a diagram showing a relationship between the attenuation of as-drawn fiber for light at a wavelength around 1.55 μm and the temperature of the as-drawn optical fiber 3 just before entering into the second cooling zone 5.

FIG. 4 is a diagram showing a drawing apparatus employed conventionally for drawing an optical fiber.

### DETAILED DESCRIPTION OF THE INVENTION

Hereinafter, the present invention will be described in detail with reference to the attached drawings.

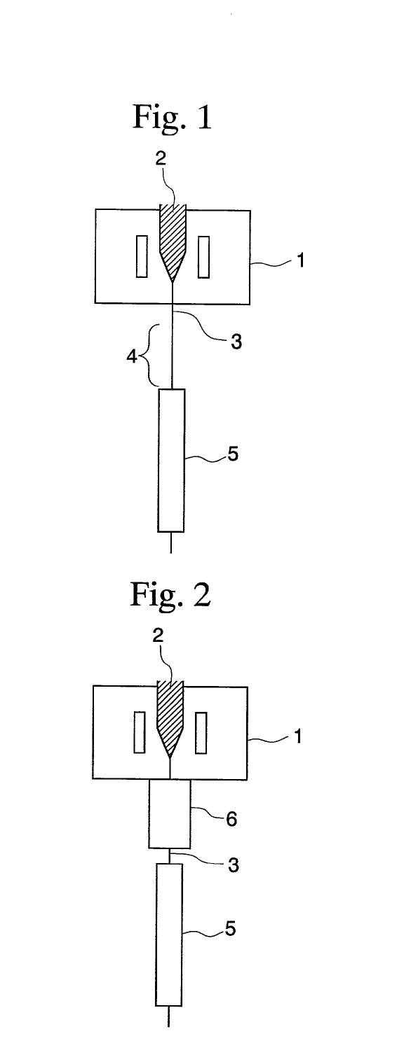

FIG. 1 is a diagram showing a cooling apparatus employed for the drawing method for an optical fiber according to the first embodiment of the present invention.

In FIG. 1, reference numeral 1 denotes a fiber-drawing furnace, which is used for melting and drawing a preform 2 at a high temperature. The reference numeral 4 denotes a first cooling zone for preliminary cooling of the optical fiber 3, and reference numeral 5 denotes a second cooling zone for rapidly cooling the optical fiber 3 to room temperature.

The first cooling zone 4 is provided between the fiber-drawing furnace 1 and the second cooling zone 5 is provided for separating the second cooling zone 5 apart from the drawing furnace 1. In the first embodiment, the first cooling zone is filled with air. In practice, a cooling apparatus such as a cooling jacket forms a second cooling zone 5.

A convection heat transfer coefficient of the first cooling zone 4 differs from that of the second cooling zone 5, and the first cooling zone 4 has a lower convection heat transfer coefficient than that of the second cooling zone 5. In practice, the convection heat transfer coefficient of the second cooling zone 5 is set at a value above 0.3 W·m⁻²·K⁻¹, whereas the convection heat transfer coefficient of the first cooling zone 4 is set at a value below 0.2 W·m⁻²·K⁻¹.

Note that the convection heat transfer coefficient H is expressed by the following equation (1), when the radiation is ignored.

$$L / V = - \frac{1}{4} \int \frac{CT ρ d}{h ( T - {T}^{′} )} ⅆ T \qquad ( 1 )$$

where, L is a length (m), V is a drawing speed (m/sec), C is the specific heat of the optical fiber (W·s·m⁻¹), T and T′ are absolute temperatures (K), ρ is the specific gravity of the optical fiber, and d is a diameter of the fiber.

Accordingly, the convection heat transfer coefficient is obtained by measuring temperatures of the fiber at two points.

Next, the drawing method according to the present embodiment is explained below.

An optical fiber 3 having a fine diameter is formed by melting and drawing a glass preform 2 in the fiber-drawing furnace 1. The optical fiber 3 maintained at a high temperature is cooled by passing through the first cooling zone 4 and the second cooling zone 5. The optical fiber 3 from the fiber-drawing furnace 1 is subjected to the preliminary cooling in the first cooling zone 4 for reducing the temperature of the optical fiber entering into the second cooling zone 5.

The optical fiber 3, after being cooled in the first cooling zone, is cooled in the second cooling zone 5 to room temperature.

Thereafter, the optical fiber 3 is coated with a coating resin and is wound by a receiving drum.

In the cooling process according to the present embodiment, since the first cooling zone 4 is set to have a lower convection heat transfer coefficient, the density variation or the concentration variation of the glass, which forms the optical fiber can be restrained.

Since the optical fiber 3 is cooled preliminary in the first cooling zone 4 before entering into the second cooling zone 5, the temperature of the optical fiber 3 is already reduced when the optical fiber is entering into the second cooling zone 5. Thereby, even when the optical fiber 3 is subsequently cooled to room temperature in the second cooling zone 5 having high convection heat transfer coefficient, the density variation or concentration variation of the glass forming the optical fiber can be suppressed and low Rayleigh scattering is realized.

In practice, the optical fiber is cooled below a temperature of 1100° C. in the first cooling zone 4. Subsequently, in the second cooling zone 5, the optical fiber 3 is rapidly cooled from a temperature below 1100° C. to room temperature. In order to cool the optical fiber 3 in the first cooling zone 4 to a temperature less than 1100° C., cooling in the first cooling zone 4 is preferably conducted for a period of time longer than 0.08 sec, after the temperature of the optical fiber 3 has decreased below the softening temperature.

In the drawing method according to the first embodiment of the present invention, it is possible to reduce the attenuation at around 1.55 μm without reducing the drawing speed by conducting a preliminary cooling in the first cooling zone 4 disposed between the fiber-drawing furnace I and the second cooling furnace 5.

Furthermore, since the present invention does not require additional equipment other than the drawing furnace and the cooling apparatus, it is possible to provide a drawing method for a low loss optical fiber without a large capital investment.

FIG. 2 is a diagram showing a cooling apparatus employed for the drawing method for an optical fiber according to the second embodiment of the present invention.

Although the drawing furnace 1 and the second cooling zone 5 are the same as those of the first embodiment, a protecting tube 6 is provided in the first cooling zone 4 of this embodiment. This protecting tube is filled with a gas such as nitrogen or a gas mixture, the heat transfer coefficient of which is below 0.05 W·m⁻¹·K⁻¹.

The drawing method according to this embodiment will be described below.

Similarly to the first embodiment, the optical fiber at a high temperature is subjected to a preliminary cooling in the first cooling zone 4, which is provided with a protecting tube 6 filled with a gas atmosphere protecting tube, the heat transfer coefficient of which is defined below 0.05 W·m⁻¹·K⁻¹.

Subsequently, the optical fiber 3 is cooled to room temperature in the second cooling zone 5 having a high convection heat transfer coefficient.

In the second embodiment, the cooling is carried out in a very efficient manner, since the preliminary cooling is conducted in a gas atmosphere having a low heat transfer coefficient.

Practical examples will be shown below.

### EXAMPLE 1

The optical fiber 3 is cooled until its temperature reaches 1100° C. in the first cooling zone 4, which has a heat transfer coefficient of lower than 0.2 W·m⁻²·K⁻¹ and the temperature of the optical fiber is reduced less than 1100° C. before the optical fiber enters into the second cooling zone 5, which has a convection heat transfer coefficient of higher than 0.3 W·m⁻²·K⁻¹. The optical fiber 3 is thereafter rapidly cooled in the second cooling zone 5 from 1100° C. to room temperature. In this embodiment, the first cooling zone 4 is filled with air.

The optical fiber obtained by the above-described cooling method exhibited the attenuation at 1.55 μm of 0.187 dB/km. The attenuation was measured by OTDR.

Several comparative examples were obtained, in which the temperatures of optical fiber at the time of entering into the second cooling zone 5 were changed and the attenuation at 1.55 μm of these comparative examples were measured also by OTDR. An explanation is provided with respect to the relationship between the temperature at the time of entering into the second cooling zone 5 and the attenuation for the light at a wavelength of 1.55 μm.

A first comparative example was obtained by setting the temperature of the optical fiber 3 at the time of entering into the second cooling zone 5 having the convection heat transfer coefficient of above 0.3 W·m⁻²·K⁻¹ after cooling in the first cooling zone 4 having the convection heat transfer coefficient of below 0.2 W·m⁻²·K⁻¹ at 1500° C., and the optical fiber 3 of this first comparative example is cooled from 1500° C. to room temperature in the second cooling zone 5. The attenuation of the as-drawn fiber by the first comparative example was 0.193 dB/Km.

A second comparative example was obtained by setting the temperature of the optical fiber 3 at the time of entering into the second cooling zone 5 having the convection heat transfer coefficient of above 0.3 W·m⁻²·K⁻¹ after cooling in the first cooling zone 4 having the convection heat transfer coefficient of below 0.2 W·m⁻²·K⁻¹ at 1200° C., and the optical fiber 3 of the second comparative example is cooled from 1200° C. to room temperature in the second cooling zone 5. The attenuation of the as-drawn fiber by the second comparative example was 0.188 dB/Km.

A third comparative example was obtained by setting the temperature of the optical fiber 3 at the time of entering into the second cooling zone 5 having the convection heat transfer coefficient of above 0.3 W·m⁻²·K⁻¹ after cooling in the first cooling zone 4 having the convection heat transfer coefficient of below 0.2 W·m⁻²·K⁻¹ at 870° C., and the optical fiber 3 of the second comparative example is cooled from 870° C. to room temperature in the second cooling zone 5. The attenuation of the as-drawn fiber by the third comparative example was 0.187 dB/Km.

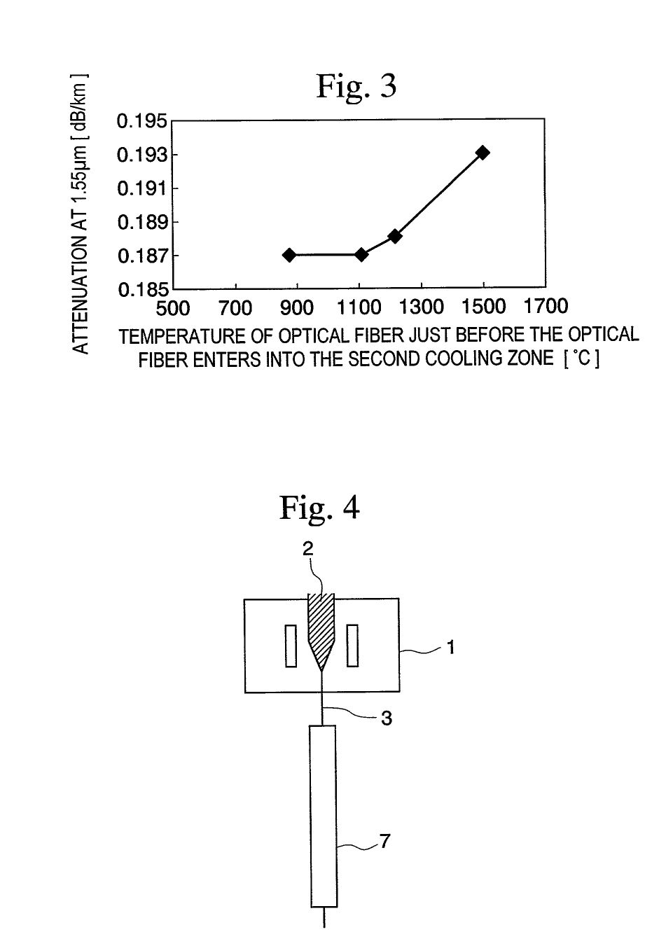

The results obtained by the above experiments are shown in FIG. 3. FIG. 3 is a diagram showing the relationship between the attenuation of as-drawn fiber for the light with a wavelength of 1.55 μm and the temperature of the as-drawn optical fiber 3 just before entering into the second cooling zone 5.

As shown in FIG. 3, it was clearly observed that the attenuation of optical fiber 3 which entered into the second cooling zone 5 at temperatures higher than 100° C. increases as the entering temperature increases. In contrast, the attenuation of optical fiber are maintained constant if the temperature at which the optical fiber 3 entered into the second cooling zone 5 was lower than 1100° C. Accordingly, it is possible to reduce the attenuation of optical fiber by simply maintaining the temperature of as-drawn fiber entering into the second cooling zone to be lower than 1100° C.

### EXAMPLE 2

In this example, a protecting tube 6 is disposed at the position of the first cooling zone 4, which is located at the lower position of the drawing furnace 1, and nitrogen was filled in the protecting tube 6. Note that the heat transfer coefficient of nitrogen at room temperature is 0.025 W·m⁻¹·K⁻¹. In the drawing process, the optical fiber 3 was subjected to preliminary cooling in the first cooling zone 4, and the optical fiber 3 was obtained after being cooled in the second cooling zone 5.

The same temperature conditions as those of the example 1 were employed in this example for cooling the optical fiber.

The attenuation at 1.55 μm of the as-drawn optical fiber obtained by the above conditions was 0.187 dB/km.

A comparative example of the example 2 was fabricated by cooling the as-drawn optical fiber in a protecting tube, filled with He gas in place of nitrogen. The heat transfer coefficient of He gas is 0.15 W·m⁻¹·K⁻¹. In the formation of this comparative example, the same temperature conditions as those of the example 1 were employed.

The attenuation of the optical fiber obtained by this example for the light band having the wavelength of 1.55 μm was 0.195 dB/km.

The above experiments showed that the heat transfer coefficient of the gas for filling the protecting tube is preferably less than 0.05 W·m⁻¹·K⁻¹.

It is preferable that the protecting tube 6 used in the Example 2 have a diameter of greater than 10 mm, and have a length which is sufficient to protect the as-drawn optical fiber at temperatures while being cooled from a temperature above the softening temperature to one below 1100° C. If the diameter of the protecting tube is smaller than 10 mm, the strength of the optical fiber may be degraded because the as-drawn fiber may contact the inner wall of the protecting tube.

As described above, it is possible to reduce the attenuation of the optical fiber for the light at a wavelength of 1.55 um without reducing drawing speed by conducting a preliminary cooling in a first cooling zone, which is disposed between the drawing furnace and the second cooling zone.

In addition, since the drawing method of the present invention does not require special equipment, the present invention provides an economic drawing system for producing low loss optical fiber without requiring heavy investment.

What is claimed is:

1. A drawing method for manufacturing optical fiber by cooling optical fiber drawn from a drawing furnace comprising:
a first cooling step for cooling optical fiber to below 1100° C. in a first cooling zone which convection heat transfer coefficient is set lower than 0.2 W·m⁻²·K⁻¹; and
a second cooling step for cooling the optical fiber at temperature below 1100° C. in a second cooling zone whose convection heat transfer coefficient is set higher than 0.3 W·m⁻²·K⁻¹.

2. A drawing method for manufacturing the optical fiber according to claim 1, wherein, in said first cooling zone filled with air, the optical fiber is naturally cooled for longer than 0.08 second after the temperature of the optical fiber reaches a temperature that is less than the softening temperature.

3. A drawing method for manufacturing optical fiber according to claim 1, wherein said first cooling zone is a zone which is filled with a gas or a gas mixture, whose heat transfer coefficient is less than 0.05 W·m⁻¹·K⁻¹.

4. A drawing method for manufacturing optical fiber according to claim 1, wherein, said first cooling zone is provided with a protecting tube which is filled with a gas or a gas mixture, whose heat transfer coefficient is less than 0.05 W·m⁻¹·K⁻¹.

5. A drawing method for manufacturing optical fiber according to claim 4, wherein said protecting tube has an inner diameter of greater than 10 mm and has a length sufficient for protecting the optical fiber while being cooled from a temperature above the transition temperature to a temperature below 1100° C.
